(19) United States
(12) Patent Application Publication
(10) Pub. No.: US 2024/0248302 A1
(43) Pub. Date: Jul. 25, 2024

(54) LIGHT FILTER, HEAD UP DISPLAY DEVICE, AND TRANSPORT MEANS

(71) Applicant: Shanghai Tianma Micro-Electronics Co., Ltd., Shanghai (CN)

(72) Inventors: Fushun WAN, Shanghai (CN); Lumang HU, Shanghai (CN); Jiandong WANG, Shanghai (CN); Xiongping LI, Shanghai (CN)

(73) Assignee: Shanghai Tianma Micro-Electronics Co., Ltd., Shanghai (CN)

(21) Appl. No.: 18/624,431

(22) Filed: Apr. 2, 2024

(30) Foreign Application Priority Data
Nov. 8, 2023 (CN) 202311484302.6

(51) Int. Cl. G02B 27/01

(52) U.S. Cl. CPC G02B 27/0101

(57) ABSTRACT

A light filter, a head up display device, and a transport means are provided. The light filter has an optical transmission region and includes an optical layer group arranged in the optical transmission region. Transmittance of the optical layer group to light within a first waveband is greater than transmittance of the optical layer group to light within a second waveband. The optical layer group includes a first layer and a second layer that are stacked together. A refractive index of the first layer is different from a refractive index of the second layer. The first layer includes a metal layer.

### CROSS-REFERENCE TO RELATED APPLICATIONS

The present application claims priority to Chinese Patent Application No. 202311484302.6, filed on Nov. 8, 2023, the content of which is incorporated herein by reference in its entirety.

### TECHNICAL FIELD

The present disclosure relates to the field of display technologies, and, particularly, relates to a light filter, a head up display device, and a transport means.

### BACKGROUND

With the continuous development of display technology, head up display (HUD) has gradually been applied in the field of transportation, such as cars. HUD can display, in the form of graphics and/or characters, the speed, fuel consumption and required navigation information during driving onto the windshield in front of the driver's seat, so that the driver does not need to look down to check instrument panel to check information such as the speed and fuel consumption while driving, which improves driving safety.

At present, external sunlight passes through the car's windshield and then passes to the image generating element in the HUD, causing the temperature of the image generating element to rise. In a severe case, the image generating element may be burned out, which greatly affects the stability of the HUD and safe driving.

### SUMMARY

In an aspect of the present disclosure, a light filter is provided. The light filter has an optical transmission region and includes an optical layer group arranged in the optical transmission region. Transmittance of the optical layer group to light within a first waveband is greater than transmittance of the optical layer group to light within a second waveband. The optical layer group includes a first layer and a second layer that are stacked together. A refractive index of the first layer is different from a refractive index of the second layer, and the first layer includes a metal layer.

In another aspect of the present disclosure, a light filter is provided. The light filter includes an optical layer group. Transmittance of the optical layer group to light within a first waveband is greater than transmittance of the optical layer group to light within a second waveband, and the optical layer group includes a long-wave passing material layer and a short-wave passing material layer that are stacked together.

In another aspect of the present disclosure, a head up display device is provided. The head up display device includes an image generating element configured to emit light within a first waveband, an imaging module configured to receive the light within the first waveband and perform imaging, and a light filter is located on an optical path between the image generating element and the imaging module.

The light filter has an optical transmission region and includes an optical layer group arranged in the optical transmission region. Transmittance of the optical layer group to light within a first waveband is greater than transmittance of the optical layer group to light within a second waveband. The optical layer group includes a first layer and a second layer that are stacked together. A refractive index of the first layer is different from a refractive index of the second layer, and the first layer includes a metal layer. Or, the light filter includes an optical layer group. Transmittance of the optical layer group to light within a first waveband is greater than transmittance of the optical layer group to light within a second waveband, and the optical layer group includes a long-wave passing material layer and a short-wave passing material layer that are stacked together.

In another aspect of the present disclosure, a transport means is provided, and the transport means includes a head up display device. The head up display device includes an image generating element configured to emit light within a first waveband, an imaging module configured to receive the light within the first waveband and perform imaging, and a light filter is located on an optical path between the image generating element and the imaging module.

The light filter has an optical transmission region and includes an optical layer group arranged in the optical transmission region. Transmittance of the optical layer group to light within a first waveband is greater than transmittance of the optical layer group to light within a second waveband. The optical layer group includes a first layer and a second layer that are stacked together. A refractive index of the first layer is different from a refractive index of the second layer, and the first layer includes a metal layer. Or, the light filter includes an optical layer group. Transmittance of the optical layer group to light within a first waveband is greater than transmittance of the optical layer group to light within a second waveband, and the optical layer group includes a long-wave passing material layer and a short-wave passing material layer that are stacked together.

### BRIEF DESCRIPTION OF DRAWINGS

In order to more clearly explain the embodiments of the present disclosure or the technical solution in the related art, the drawings used in the description of the embodiments or the related art will be briefly described below. The drawings in the following description are some embodiments of the present disclosure. Those skilled in the art can obtain other drawings based on these drawings.

FIG. 1 is a cross-sectional view of a light filter provided by some embodiments of the present disclosure;

FIG. 2 is a schematic diagram of a HUD provided by some embodiments of the present disclosure;

FIG. 3 is a graph showing a curve of transmittance of an optical layer group to light of different wavelengths provided by some embodiments of the present disclosure;

FIG. 4 is another cross-sectional view of a light filter provided by some embodiments of the present disclosure;

FIG. 5 is a schematic top view of a light filter provided by some embodiments of the present disclosure;

FIG. 6 is another cross-sectional view of a light filter provided by some embodiments of the present disclosure;

FIG. 7 is another cross-sectional view of a light filter provided by some embodiments of the present disclosure;

FIG. 8 is another cross-sectional view of a light filter provided by some embodiments of the present disclosure;

FIG. 9 is another cross-sectional view of a light filter provided by some embodiments of the present disclosure;

FIG. 10 is another cross-sectional view of a light filter provided by some embodiments of the present disclosure;

FIG. 11 is another cross-sectional view of a light filter provided by some embodiments of the present disclosure;

FIG. 12 is a schematic diagram of a positional relationship between a light filter and an image generating element provided by some embodiments of the present disclosure;

FIG. 13 is another schematic diagram of a positional relationship between a light filter and an image generating element provided by some embodiments of the present disclosure;

FIG. 14 is another schematic diagram of a positional relationship between a light filter and an image generating element provided by some embodiments of the present disclosure;

FIG. 15 is another schematic diagram of a positional relationship between a light filter and an image generating element provided by some embodiments of the present disclosure;

FIG. 16 is another schematic diagram of a positional relationship between a light filter and an image generating element provided by some embodiments of the present disclosure;

FIG. 17 is another schematic diagram of a positional relationship between a light filter and an image generating element provided by some embodiments of the present disclosure;

FIG. 18 is another schematic diagram of a positional relationship between a light filter and an image generating element provided by some embodiments of the present disclosure;

FIG. 19 is another schematic diagram of a positional relationship between a light filter and an image generating element provided by some embodiments of the present disclosure;

FIG. 20 is another schematic diagram of a positional relationship between a light filter and an image generating element provided by some embodiments of the present disclosure; and

FIG. 21 is a schematic diagram of a transport means provided by some embodiments of the present disclosure.

### DESCRIPTION OF EMBODIMENTS

In order to better understand technical solutions of the present disclosure, the embodiments of the present disclosure are described in detail with reference to the drawings.

It should be clear that the described embodiments are merely part of the embodiments of the present disclosure rather than all of the embodiments. Based on the embodiments of present application, all other embodiments obtained by those skilled in the art shall fall within the scope of the protection of present application.

It should be understood that the term “and/or” used in the context of the present disclosure is to describe a correlation relation of related objects, indicating that there can be three relations, e.g., A and/or B can indicate only A, both A and B, and only B. The symbol “/” in the context generally indicates that the relation between the objects in front and at the back of “/” is in an “or” relationship.

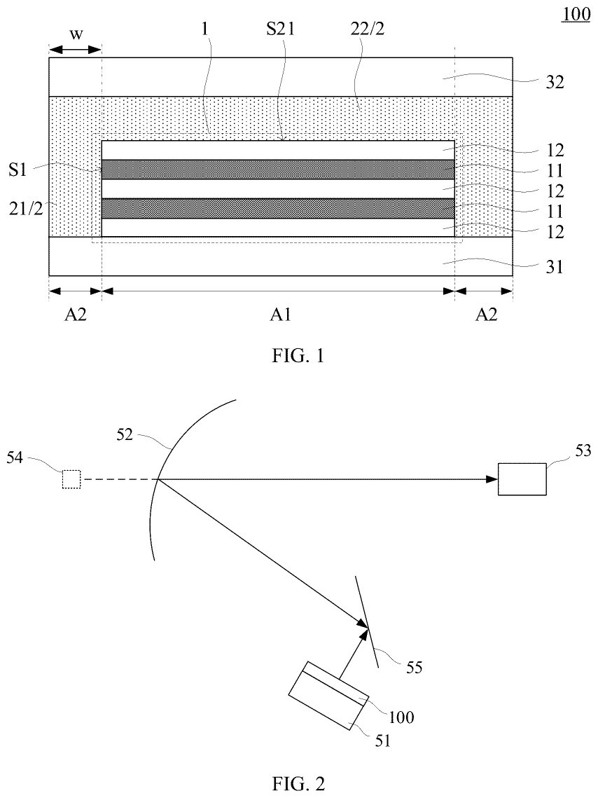

Some embodiments of the present disclosure provide a light filter. FIG. 1 is a cross-sectional view of a light filter 100 provided by some embodiments of the present disclosure. As shown in FIG. 1, the light filter 100 has an optical transmission region A1 and includes an optical layer group 1 provided in the optical transmission region A1. Transmittance of the optical layer group 1 to light within a first waveband is greater than transmittance of the optical layer group 1 to light within a second waveband, and the first waveband and the second waveband do not overlap. That is, the optical layer group 1 is a wavelength-selective optical device capable of transmitting light of a specific wavelength.

When composite light including light within the first waveband and light within the second waveband passes through the optical layer group 1, the light within the second waveband in the composite light can be weakened or even eliminated based on the reflection or absorption mechanism, so that intensity of the light within the second waveband in light exiting via the optical layer group 1 is smaller than intensity of light within the second waveband in light incident on the optical layer group 1. At the same time, intensity of the light within the first waveband in the light exiting via the optical layer group 1 and intensity of the light within the first waveband in the light incident on the optical layer group 1 are not changed or are within an acceptable loss range.

For example, the light filter 100 may be used in an optical system that utilizes the light within the first waveband and weakens or isolates the light within the second waveband. In some embodiments, the optical system includes a HUD. FIG. 2 is a schematic diagram of a HUD provided by some embodiments of the present disclosure. As shown in FIG. 2, the HUD includes an image generating element 51, an imaging module 52, and a light filter 100. The image generating element 51 may emit display light with a wavelength within the first waveband according to display information. The display information includes information such as a current speed and/or navigation. The display light is reflected by the imaging module 52, and then the reflected light can reach an eye box 53. When the driver's eyes are within a range of the eye box 53, a virtual image 54 formed by the display light at another side of the imaging module 52 can be observed, which allows the driver to view information such as speed and/or navigation without turning or lowering his head, thereby improving driving safety.

Exemplarily, in some embodiments of the present disclosure, the light filter 100 can be disposed on an optical path between the image generating element 51 and the imaging module 52. FIG. 2 illustrates an example in which the light filter 100 is disposed on a light-exiting surface of the image generating element 51. Based on the above-described arrangement, during the process of sunlight passing through the imaging module 52 and then being incident to the image generating element 51, light within the second waveband in the sunlight can be weakened or even eliminated after passing through the light filter 100, thereby reducing heat reaching the image generating element 51, lowering the temperature of the image generating element 51, and improving the reliability of the image generating element 51. At the same time, since the light filter 100 has a high transmittance for light within the first waveband, when the HUD operates, the light within the first waveband emitted by the image generating element 51 can smoothly reach the imaging module 52 after passing through the light filter 100. That is, the intensity of the light within the first waveband emitted by the image generating element 51 and received by the imaging module 52 can be ensured, thereby ensuring the display quality. That is to say, with the light filter 100, the display quality is ensured while heat carried by the light within the second waveband reaching the image generating element 51 can be reduced, thereby avoiding an increase in the temperature of the image generating element 51 and improving reliability of the image generating element 51.

In some embodiments, the values of the first waveband and the second waveband can be designed according to the application environment of the above optical system. For example, when the light filter 100 is applied in the HUD, a wavelength λ1 of the light within the first waveband satisfies 400 nm≤λ1≤780 nm, that is, the light within the first waveband including visible light within sunlight. The light within the second waveband may include other light within sunlight except the visible light. For example, a wavelength λ2 of the light within the second waveband satisfies 10 nm≤λ2≤400 nm or 780 nm≤λ2≤5300 nm. That is, the light within the second waveband includes ultraviolet light and/or infrared light. For example, transmittance of the optical layer group 1 to the visible light is greater than or equal to 80%, and transmittance of the optical layer group 1 to ultraviolet light or infrared light is smaller than or equal to 10%. That is, the visible light passes through the optical layer group 1, whereas ultraviolet light and infrared light are blocked by the optical layer group 1. Energy of infrared light and energy of ultraviolet light accounts for about 68% of energy of the sunlight. Based on such design, the intensity of sunlight passing through the optical layer group 1 can be reduced, and when applying the light filter in the HUD shown in FIG. 2, an increase in the temperature of the image generating element 51 in the HUD can be avoided.

When arranging the light filter 100, for example, as shown in FIG. 1, the optical layer group 1 may include a first layer 11 and a second layer 12 that are stacked together, the first layer 11 and the second layer 12 have different refractive indices, and the first layer 11 includes a metal layer.

In the embodiments of the present disclosure, the transmittance of the optical layer group 1 of the light filter 100 to light within the first waveband is greater than the transmittance of the optical layer group 1 to the light within the second waveband, which can ensure that the light within the first waveband passes through the optical layer group smoothly while reducing or isolating the light within the second waveband to pass through. In this way, when the light filter 100 is applied in the optical systems such as HUD, it can be ensured that the light within the first waveband passes through smoothly to utilize the light within the first waveband to achieve functions such as imaging, while it is avoided that the temperature of devices such as the above image generating element 51 in the optical system is increased due to the irradiation of the light within the second waveband, which is beneficial to improving reliability of the image generating component 51.

In the embodiments of the present disclosure, the first layer 11 includes a metal layer, which improves ability of the optical layer group 1 to reflect the infrared light within the light within the second waveband to reduce the transmittance of the infrared light. In this way, the optical layer group 1 has better spectral selecting characteristics, which improves the thermal insulation effect of light filter 100. While improving the refractive index of the optical layer group 1 to the light within the second waveband by the first layer 11 provided with the metal layer, in the embodiments of the present disclosure, the second layer 12 stacked with the first layer 11 and having a refractive index different from the refractive index of the first layer 11 is provided. In this way, on the one hand, the second layer 12 cooperates with the first layer 11 to transmit the light within the first waveband and the light within the second waveband is weakened or isolated, that is, the optical layer group 1 including the first layer 11 and the second layer 12 has a wavelength selectivity. On the other hand, the second layer 12 can also be used to reduce the reflection of the optical layer group 1, including the first layer 11 made of the metal layer, to the light within the first waveband, ensuring that the optical layer group 1 has a high transmittance to the light within the first waveband. For example, when the light within the first band is visible light, with the second layer 12, the refractive index of the optical layer group 1 to visible light can be smaller than or equal to 15%, which is beneficial to improving a glare problem. When the light filter 100 including the optical layer group 1 is used in an optical system such as the HUD, the display effect can be improved, which prevents it from affecting driving. The second layer 12 can also protect the first layer 11, preventing corrosive media such as water and oxygen in the external environment from intruding through the second layer 12 and then corroding the first layer 11. In this way, the first layer 11 made of the metal layer is prevented from being corroded by water and oxygen in the external environment, which is beneficial to improving the reliability of the first layer 11 and extending the service life of the light filter 100 including the first layer 11.

In some embodiments, thicknesses and refractive indices of the first layer 11 and the second layer 12 are designed so that the optical layer group 1 has different transmission spectra.

For example, the number of layers, the refractive index, and the thickness of the first layer 11, and the number of layers, the refractive index, and the thickness of the second layer 12 can be determined according to the range of the first waveband and the range of the second waveband.

In some embodiments of the present disclosure, the refractive index of the first layer 11 is n₁, and the refractive index of the second layer 12 is n₂, where 1.8≤n₂−n₁≤2.75. Within this range, the optical layer group 1 can have a higher transmittance for the light within the first waveband and a lower transmittance for the light within the second wavelength band, that is, the optical layer group 1 can have a better spectral selecting performance.

For example, in some embodiments of the present disclosure, 0.04≤n₁≤0.06, and 1.5≤n₂≤2.4.

In some embodiments, the first layer 11 includes any one of or an alloy of two or more of silver, iron, nickel, titanium, copper, tin, or aluminum. The second layer 12 includes an oxide. Exemplarily, the oxide includes a metal oxide. For example, the metal oxide includes any one of indium tin oxide (ITO), antimony tin oxide (ATO), aluminum oxide (Al₂O₃), zirconium dioxide (ZrO₂), and titanium dioxide (TiO₂). In other embodiments of the present disclosure, the second layer 12 may also be made of silicon dioxide (SiO₂).

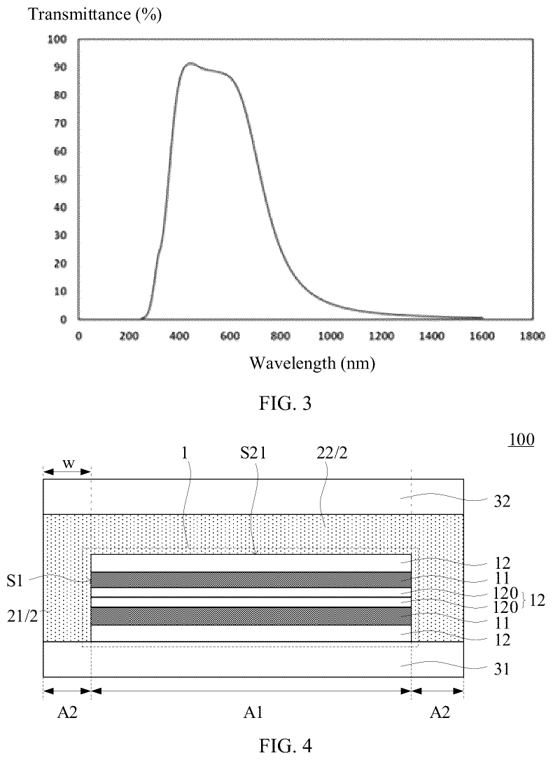

FIG. 3 is a graph of a curve of transmittance of an optical layer group to light of different wavelengths provided by some embodiments of the present disclosure. In combination with FIG. 3, the optical layer group includes two first layers 11 and three second layers 12. The first layer 11 includes silver (Ag), and the second layer 12 includes indium tin oxide (ITO). The first layers 11 are alternately arranged with the second layers 12, that is, forming an ITO/Ag/ITO/Ag/ITO structure. A thickness d1 of the first layer 11 satisfies 8 nm≤d1≤12 nm, a thickness d2 of the second layer 12 disposed in the middle of the optical layer group 1 satisfies 80 nm≤d2≤100 nm, and a thickness d2 of each of the second layers 12 located at two sides of the optical layer group 1 satisfies 35 nm≤d2≤40 nm. As shown in FIG. 3, the transmittance of the optical layer group to light within the visible light waveband is greater than 80%, and an average transmittance of the optical layer group to light within the ultraviolet waveband and light within infrared waveband is smaller than 10%.

FIG. 4 is another schematic diagram of a light filter 100 provided by some embodiments of the present disclosure. Exemplarily, as shown in FIG. 4, the second layer 12 can include at least two sub-layers 120 stacked together. FIG. 4 illustrates an example in which the second layer 12 includes two sub-layers 120. With the configuration where the second layer 12 includes at least two stacked sub-layers 120, the degree of freedom in regulating the optical performance of the optical layer group 1 can be increased.

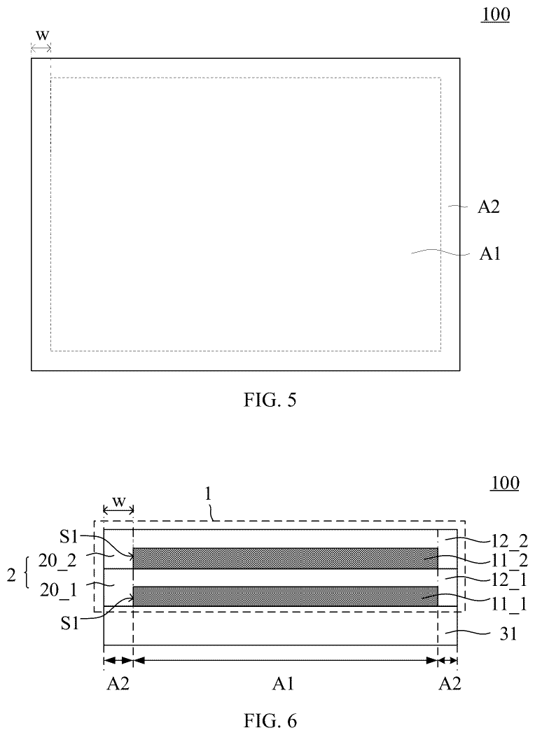

FIG. 5 is a schematic top view of a light filter 100 provided by some embodiments of the present disclosure. In some embodiments, as shown in FIG. 1, FIG. 4, and FIG. 5, the light filter 100 also includes an encapsulation region A2 surrounding the optical transmission region A1. As shown in FIG. 1 and FIG. 4, the light filter 100 also includes an encapsulation layer 2, at least part of the encapsulation layer 2 is located in the encapsulation region A2, the encapsulation layer 2 is at least in contact with a side surface S1 of the first layer 11, and the side surface S1 of the first layer 11 intersects a plane of the light filter 100.

The part of the encapsulation layer 2 located in the encapsulation region A2 can prevent water vapor from entering from the side surface S1 of the first layer 11 and eroding the first layer 11, thereby protecting the first layer 11 made of the metal layer from being eroded by water and oxygen in external environment. In this way, the possibility that the first layer 11 in the light filter 100 is oxidized and corroded is reduced, extending the life of the light filter 100 and improving the reliability of the light filter 100. In the embodiments of the present disclosure, the encapsulation layer 2 is in contact with the side surface S1 of the first layer 11, the encapsulation layer 2 and the second layer 12 that is in contact with the surface of the first layer 11 can jointly enclose the first layer 11, and then the first layer 11 can be isolated from the external environment in multiple directions, improving the reliability of the light filter 100 including the first layer 11.

Exemplarily, as shown in FIG. 1 and FIG. 4, the encapsulation layer 2 includes a first part 21 and a second part 22, the first part 21 is located in the encapsulation region A2 and the first part 21 is in contact with the side surface S1 of the first layer 11, and the second part 22 is located in the optical transmission region A1 and is in contact with a first surface S21 of the optical layer group 1. For example, the second part 22 may be attached to the first surface S21 of the optical layer group 1, and the first surface S21 is parallel to the plane of the light filter 100. In the embodiments of the present disclosure, the encapsulation layer 2 includes the first part 21 and the second part 22, such that the encapsulation layer 2 can enclose the optical layer group 1 in multiple directions, improving the encapsulation reliability of the light filter 100.

In some embodiments, as shown in FIG. 1 and FIG. 4, the first surface S21 includes a surface of the second layer 12 away from the first layer 11. That is, the second layer 12 is located at the outermost side of the optical layer group 1. Based on such configuration, the surface of the first layer 11 can be enclosed, inside the optical layer group 1, by the second layer 12, and the surface of the first layer 11 is parallel to the plane of the light filter 100 to avoid the surface of the first layer 11 made of metal layer to be exposed at the outermost side of the optical layer group 1, thereby reducing the corrosion possibility of the first layer 11, and improving the reliability of the optical layer group 1 including the first layer 11.

For example, as shown in FIG. 1 and FIG. 4, the first part 21 and the second part 22 are formed into one piece.

In some embodiments, as shown in FIG. 1 and FIG. 4, the light filter 100 also includes a first substrate 31. The optical layer group 1 is located at a side of the first substrate 31, and the first substrate 31 can serve as a carrier substrate for each layer of the optical layer group 1.

When preparing the light filter 100 with the structure shown in FIG. 1, for example, in some embodiments of the present disclosure, the first substrate 31 is first provided and is divided into the optical transmission region A1 and the encapsulation region A2. Then, the optical layer group 1 including the first layer 11 and the second layer 12 and at least partially located in the optical transmission region A1, is prepared at a side of the first substrate 31. The preparation of the first layer 11 and the second layer 12 of the optical layer group 1 includes layer formation and etching process. For example, layer formation can adopt physical vapor deposition (PVD) or chemical vapor deposition (CVD). Etching the first layer 11 and the second layer 12 can make the dimensions of the two layers meet the design requirements. After the optical layer group 1 including the first layer 11 and the second layer 12 is prepared, the encapsulation layer 2 with a larger area covering the optical layer group 1 can be formed, and the encapsulation layer 2 includes the first part 21 located in the encapsulation region A2 and the second part 22 located in the optical transmission region A1.

In the embodiments of the present disclosure, the first part 21 and the second part 22 are formed into one piece. On the one hand, the preparation process of the encapsulation layer 2 can be simplified. On the other hand, it is avoided that an interface between the first part 21 and the second part 22 (the interface may serve as a path for water and oxygen in the external environment to invade the first layer 11) is formed, thereby improving the compactness of the encapsulation layer 2.

For example, as shown in FIG. 1 and FIG. 4, in some embodiments of the present disclosure, a thickness of the second part 22 is greater than a thickness of the second layer 12, and the thickness of the second part 22 is also greater than the thickness of the first layer 11. With such configuration, on the one hand, the second part 22 can have a sufficient thickness to ensure the encapsulation effect of the second part 22, on the other hand, it can also prevent the second part 22 of the encapsulation layer 2 from affecting the optical properties of the optical layer group 1, to ensure that the optical layer group 1 can meet the requirement that the transmittance of light within the first waveband is greater than the transmittance of light within the second waveband.

In some embodiments, the first part 21 and the second part 22 include optical clear adhesive. The optical clear adhesive has a high transmittance to the light within the first waveband. In this way, the reliability of the encapsulation can be ensured, and, at the same time, it can also be ensured that the encapsulation layer 2 still has a high transmittance to the light within the first waveband, which will avoid that the encapsulation layer 2 affects the transmission of light within the first waveband in the optical transmission region A1.

For example, as shown in FIG. 1 and FIG. 4, after the encapsulation layer 2 is prepared, a second substrate 32 can be disposed at a side of the encapsulation layer 2 away from the first substrate 31, and the second substrate 32 can protect the optical layer group 1. In some embodiments, optical clear adhesive can bond the first substrate 31 and the second substrate 32.

In some embodiments, as shown in FIG. 1 and FIG. 4, in some embodiments of the present disclosure, the optical layer group 1 includes at least two second layers 12, and the first layer 11 is located between two second layers 12. The two second layers 12 and the first part 21 of the encapsulation layer 2 located in the encapsulation region A2 can protect the first layer 11 from all sides of the first layer 11 and can effectively prevent water and oxygen in the external environment from corroding the first layer 11. With the configuration of at least two second layers 12, the degree of freedom in regulating the optical performance of the optical layer group 1 can be increased.

FIG. 6 is another cross-sectional view of a light filter 100 provided by some embodiments of the present disclosure. Exemplarily, as shown in FIG. 6, the encapsulation layer 2 includes at least two encapsulation sub-layers 20 that are stacked along a thickness direction of the light filter 100, and the encapsulation sub-layers 20 are formed into one piece with the second layer 12 that is closest to the encapsulation sub-layers 20. FIG. 6 illustrates that the optical layer group 1 includes two second layers 12 and two first layers 11, and the encapsulation layer 2 includes two encapsulation sub-layers 20. For distinction, in FIG. 6, the two second layers are denoted by 12_1 and 12_2, respectively, the two first layers are denoted by 11_1 and 11_2, respectively, and the two encapsulation sub-layers are denoted by 20_1 and 20_2, respectively. In the optical transmission region A1, the first layer 11_1, the second layer 12_1, the first layer 11_2, and the second layer 12_2 are stacked in sequence along a direction away from the first substrate 31. In some embodiments of the present disclosure, the encapsulation sub-layer 20_1 and the second layer 12_1 are formed into one piece, and the encapsulation sub-layer 20_2 and the second layer 12_2 are formed into one piece.

When preparing the light filter 100 with the structure shown in FIG. 6, for example, in some embodiments of the present disclosure, the first layer 11_1 may be prepared at a side of the first substrate 31 firstly. The preparation of the first layer 11_1 can includes steps, such as, layer formation and etching. Then, the second layer 12_1 is prepared. An area of the second layer 12_1 is larger than an area of the first layer 11_1, so that the second layer 12_1 not only covers the surface of the first layer 11_1, but also covers the side surface S1 of the first layer 11_1. A portion of the second layer 12_1 that is in contact with a side surface S1 of the first layer 11_1 is reused as the encapsulation sub-layer 20_1. After the preparation of the second layer 12_1 is completed, the first layer 11_2 is prepared at a side of the second layer 12_1 away from the first layer 11_1. For example, an area of the first layer 11_2 is smaller than an area of the second layer 12_1. The preparation of the first layer 11_2 includes steps, such as layer formation and etching. Then, the second layer 12_2 is prepared. The second layer 12_2 not only covers the surface of the first layer 11_2, but also covers the side surface S1 of the first layer 11_2. A portion of the second layer 12_2 that is in contact with a side surface S1 of the first layer 11_1 is reused as the encapsulation sub-layer 20_2.

When the light filter 100 includes at least two first layers 11 and at least two second layers 12, the encapsulation sub-layer 20 and the second layer 12 closest to the encapsulation sub-layer 20 are formed into one piece. On the one hand, the preparation process of the light filter 100 is simplified without preparing an additional encapsulation layer. On the other hand, each first layer 11 in the multiple first layers 11 can also be surrounded and encapsulated by the encapsulation sub-layer 20 and the second layer 12 that are adjacent to this first layer 11, and it is also avoided that an interface between the encapsulation sub-layer 20 and its closest second layer 12 (the interface may serve as a path along which water vapor invades) is formed, thereby improving encapsulation compactness. A sum of the thicknesses of all first layers 11 and all second layers 12 of the optical layer group 1 is on an order of microns or less than 1 micron. The encapsulation sub-layer 20 and the second layer 12 are formed into one piece, which is easy to form the encapsulation sub-layer that is in a same order (such as the order of microns or less than 1 micron) as the thicknesses of the first layer 11 and the second layer 12 of the optical layer group.

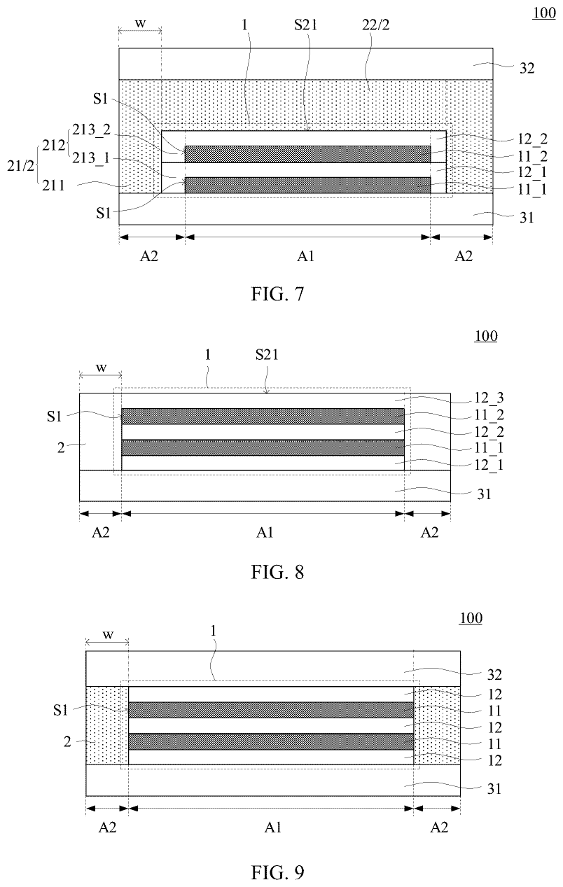

FIG. 7 is another cross-sectional view of a light filter 100 provided by some embodiments of the present disclosure. In some embodiments of the present disclosure, as shown in FIG. 7, the first part 21 in contact with the side surface S1 of the first layer 11 can include a first sub-part 211 and a second sub-part 212. The first sub-part 211 and the second sub-part 212 are arranged in a direction from the encapsulation region A2 to the optical transmission region A1. The second sub-part 212 is located at a side of the first sub-part 211 adjacent to the optical transmission region A1 and is in contact with the side surface S1 of the first layer 11. For example, in some embodiments of the present disclosure, the second sub-part 212 may include at least two third sub-parts that are stacked together, and the third sub-part and the second layer 12 closest to the third sub-part may be formed into one piece. FIG. 7 illustrates that the optical layer group 1 includes two second layers 12 and two first layers 11, and the second sub-part 212 includes two third sub-parts 213 that are stacked together. For distinction, in FIG. 7, the two second layers are denoted by 12_1 and 12_2, respectively, the two first layers are denoted by 11_1 and 11_2, respectively, and the two third sub-parts are denoted by 213_1 and 213_2. In the optical transmission region A1, along the direction away from the first substrate 31, the first layer 11_1, the second layer 12_1, the first layer 11_2, the second layer 12_2, and the second part 22 are stacked in sequence. The third sub-part 213_1 and the second layer 12_1 are formed into one piece, and the third sub-part 213_2 and the second layer 12_2 are formed into one piece.

As shown in FIG. 7, the encapsulation layer 2 further includes a second part 22, and the second part 22 and the first sub-part 211 are formed into one piece. In some embodiments, the second part 22 and the first sub-part 211 include optical clear adhesive.

When preparing the light filter 100 with the structure shown in FIG. 7, for example, in some embodiments of the present disclosure, the first layer 11_1 may be prepared at a side of the first substrate 31. The preparation of the first layer 11_1 may include steps, such as layer formation and etching. Then, a second layer 12_1 is prepared. An area of the second layer 12_1 is larger than an area of the first layer 11_1, so that the second layer 12_1 not only covers a surface of the first layer 11_1, but also covers a side surface S1 of the first layer 11_1. A portion of the second layer 12_1 that is in contact with the side surface S1 of the first layer 11_1 is reused as the third sub-portion 213_1. After the preparation of the second layer 12_1 is completed, the first layer 11_2 is prepared at a side of the second layer 12_1 away from the first layer 11_1. For example, an area of the first layer 11_2 is smaller than an area of the second layer 12_1. The preparation of the first layer 11_2 includes steps such as layer formation and etching. Then, the second layer 12_2 is prepared. The second layer 12_2 not only covers a surface of the first layer 11_2, but also covers a side surface S1 of the first layer 11_2, and a portion of the side surface S1 of the second layer 12_2 that is in contact with the first layer 11_2 is reused as the third sub-part 213_2. Then, the first sub-part 211 and the second part 22 are prepared. The second part 22 is located above the second layer 12_2, and the first sub-part 211 is in contact with both the third sub-part 213_1 and the third sub-part 213_2.

In the embodiments of the present disclosure, the first part 21 in contact with the side surface S1 of the first layer 11 includes the first sub-part 211 and the second sub-part 212, which can form at least two barriers protecting the side surface S1 of the first layer 11 in the encapsulation region A2 to prevent the first layer 11 from being corroded and improve the reliability of the first layer 11. In the embodiments of the present disclosure, the second sub-part 212 includes at least two third sub-parts 213 that are stacked together, and the third sub-part 213 and its closest second layer 12 are formed into one piece. On the one hand, the preparation process of the light filter 100 is simplified without an additional step of preparing the second sub-part 212. On the other hand, the formation of an interface between the third sub-part 213 and its closest second layer 12 (the interface may serve as a path along which water vapor invades) is avoided, thereby improving the encapsulation compactness.

For example, in some embodiments of the present disclosure, the second layer 12 located at the outermost side of the optical layer group 1 and the encapsulation layer 2 are formed into one piece, and this second layer 12 located at the outermost side of the optical layer group 1 is the second layer 12 with the largest distance from the first substrate 31. FIG. 8 is another cross-sectional view of a light filter provided by some embodiments of the present disclosure. As shown in FIG. 8, the optical layer group 1 includes three second layers and two first layers. For distinction, in FIG. 8, the three second layers are denoted by 12_1, 12_2, and 12_3, respectively, and the two first layers are denoted by 11_1 and 11_2, respectively. The outermost second layer in FIG. 8 is the second layer 12_3.

When preparing the light filter 100 with the structure shown in FIG. 8, for example, the first substrate 31 may be provided first and may be divided into the optical transmission region A1 and the encapsulation region A2, and then the second layer 12_1, the first layer 11_1, the second layer 12_2, and the first layer 11_2 that are at least partially located in the optical transmission region A1 are sequentially prepared at a side of the substrate 31. In some embodiments, the preparations of the second layer 12_1, the first layer 11_1, the second layer 12_2, and the first layer 11_2 include steps such as layer formation and etching. In the embodiments of the present disclosure, the second layer 12_1, the first layer 11_1, the second layer 12_2, and the first layer 11_2 are etched, so that they can have required sizes. After the preparation of the first layer 11_2 is completed, the second layer 12_3 can be formed at a side of the first layer 11_2 away from the first substrate 31. The second layer 12_3 can cover the second layer 12_1, the first layer 11_1, the second layer 12_2, and the side surface and the surface of the first layer 11_2. Such configuration is equivalent to reuse the portions of the second layer 12_3 that are in contact with the second layer 12_1, the first layer 11_1, the second layer 11_2, and the side surface of the first layer 11_2 as the encapsulation layer 2. For example, the second layer 12 can be made of a material that have a good performance at isolating water vapor to ensure the encapsulation effect.

In the embodiments of the present disclosure, the second layer 12 located at the outermost of the optical layer group 1 and the encapsulation layer 2 are formed into one piece without providing an additional encapsulation layer 2, simplifying the preparation process of the light filter 100 and reducing the thickness of the light filter 100.

Exemplarily, as shown in FIG. 1, FIG. 4, and FIG. 7, the light filter 100 includes a second substrate 32 located at a side of the optical layer group 1 away from the first substrate 31 and configured to protect the optical layer group 1.

In some embodiments, the first substrate 31 and the second substrate 32 include any one of glass, polymethylmethacrylate (PMMA), and polycarbonate (PC).

FIG. 9 is another cross-sectional view of a light filter 100 provided by some embodiments of the present disclosure. Exemplarily, as shown in FIG. 9, the encapsulation layer 2 is located between the first substrate 31 and the second substrate 32. The encapsulation layer 2 is located only in the encapsulation region A2 and is not provided in the optical transmission region A1, and the encapsulation layer 2 is in contact with both the first substrate 31 and the second substrate 32.

When preparing the light filter 100 with the structure shown in FIG. 9, for example, the first substrate 31 is provided first, and the first substrate 31 is divided into the optical transmission region A1 and the encapsulation region A2. Then, the second layer 12 and the first layer 11 that are at least partially located in the optical transmission region A1 are prepared at a side of the first substrate 31. The preparations of the first layer 11 and the second layer 12 includes steps such as layer formation and etching. In embodiments of the present disclosure, the first layer 11 and the second layer 12 can be etched to be designed to have target sizes. After the preparation of the optical layer group 1 including the first layer 11 and the second layer 12 is completed, the encapsulation layer 2 can be prepared in the encapsulation region A2, and then the second substrate 32 is provided, and the second substrate 32 and the first substrate 31 can be bonded together via the encapsulation layer 2.

In the embodiment of the present disclosure, the encapsulation layer 2 is not provided in the optical transmission region A1, which can not only ensure the encapsulation reliability of the light filter 100 but also prevent the encapsulation layer 2 from affecting the optical performance of the light filter 100.

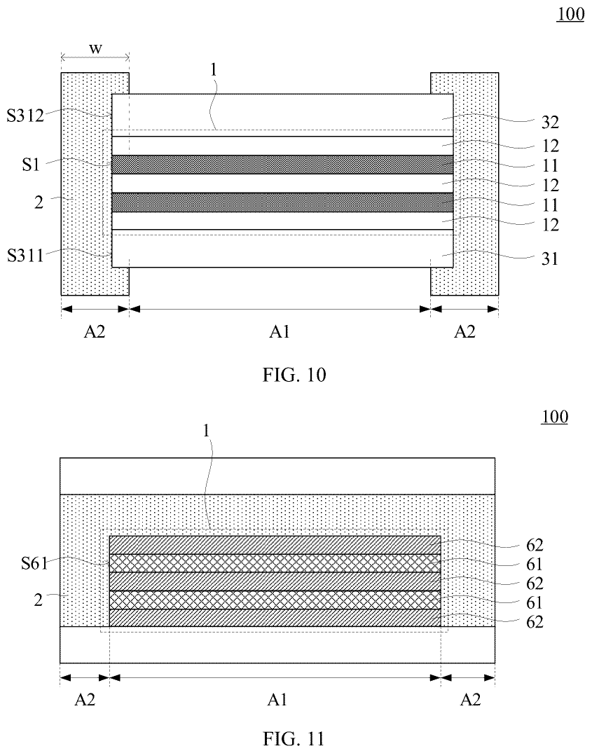

FIG. 10 is another cross-sectional view of a light filter 100 provided by some embodiments of the present disclosure. In some embodiments, as shown in FIG. 10, the encapsulation layer 2 is also in contact with a side surface S311 of the first substrate 31 and/or a side surface S321 of the second substrate 32, and the side surface S311 of the first substrate 31 and the side surface S321 of the second substrate 32 both intersect with the plane of the light filter 100.

When preparing the light filter 100 with the structure shown in FIG. 10, for example, in some embodiments of the present disclosure, the first substrate 31 is provided first, and is divided into the optical transmission region A1 and the encapsulation region A2. Then, the optical layer group 1 including a first layer 11 and a second layer 12 and at least partially located in the optical transmission region A1 is prepared at a side of the first substrate 31. After the optical layer group 1 including the first layer 11 and the second layer 12 is prepared, the second substrate 32 can cover at a side of the optical layer group 1 away from the first substrate 31. Then, the first substrate 31, the optical layer group 1 and the second substrate 32, as a whole, can be cut to form a required size. After cutting, the encapsulation layer 2 that is in contact with the side surface S311 of the first substrate 31, the side surface S321 of the second substrate 32, and the side surface S1 of the first layer 11 is provided to form the light filter 100.

Based on the structure shown in FIG. 10, a layer can be formed on the entire surface of the first substrate 31 to form the first layer 11 and the second layer 12. Subsequently, the first substrate 31, the second substrate 32, and the optical layer group 1, as a whole, can be cut, so that the optical layer group 1 has a required size without etching the first layer 11 and the second layer 12, which is beneficial to simplifying the preparation process of the light filter 100.

For example, as shown in FIG. 1, FIG. 4, FIG. 5, FIG. 6, FIG. 7, FIG. 8, FIG. 9 and FIG. 10, the encapsulation region A2 has a width w, where 0.5 mm≤w≤3 mm. A width direction is parallel to the plane of the light filter 100, and is also perpendicular to an extension direction of an edge of the light filter 100 at a corresponding position. In the embodiment of the present disclosure, w≥0.5 mm, so that the layer located in the encapsulation region can have a long enough path to block water and oxygen, thereby ensuring the encapsulation effect. At the same time, in the embodiments of the present disclosure, w≤3 mm, so that can it is avoided the excessive large width of the encapsulation region A2 occupies an area of the optical transmission region A1, which ensures that the light filter 100 has enough optical transmission area.

In some embodiments, the present disclosure also provides a light filter. FIG. 11 is another cross-sectional view of a light filter 100 provided by some embodiments of the present disclosure. As shown in FIG. 11, the light filter 100 includes an optical layer group 1, a transmittance of the optical layer group 1 to the light within the first waveband is greater than a transmittance of the optical layer group 1 to the light within the second waveband, and the first waveband and the second waveband do not overlap.

For example, as shown in FIG. 11, the optical layer group 1 includes a long-wave passing material layer 61 and a short-wave passing material layer 62 that are stacked together. The long-wave passing material layer 61 allows light of a wavelength longer than a first selected wavelength to pass through, and blocks light of a wavelength shorter than the first selected wavelength. The short-wave passing material layer 62 allows light of a wavelength shorter than a second selected wavelength to pass through, and blocks light of a wavelength longer than the second selected wavelength. The first selected wavelength and the second selected wavelength may be the same or different from each other.

In the embodiments of the present disclosure, the optical layer group 1 includes the long-wave passing material layer 61 and the short-wave passing material layer 62 that are stacked together, and the long-wave passing material layer 61 and the short-wave passing material layer 62 are in cooperation, so the optical layer group 1 has a wavelength selectivity, and the transmittance of light within the first wavelength band is greater than the transmittance of light within the second wavelength band. When the light filter 100 is used in an optical system such as a HUD, it is ensured that light within the first waveband smoothly passes to utilize the light within the first waveband to achieve functions such as imaging, and it is also avoided that the irradiation of light within the second waveband causes the temperature increase of elements in the optical system, such as the image generating element, thereby improving the reliability of the image generating element.

Exemplarily, the long-wave passing material layer 61 includes metal, and the short-wave passing material layer 62 includes an oxide layer. In some embodiments, a thickness, refractive index and number of layers of the long-wave passing material layer 61 and a thickness, refractive index and number of layers of the short-wave passing material layer 62 can be set according to the first selected wavelength and the second selected wavelength.

In some embodiments, as shown in FIG. 11, the light filter 100 has an optical transmission region A1 and an encapsulation region A2, and at least part of the optical layer group 1 is located in the optical transmission region A1. The light filter 100 includes an encapsulation layer 2. At least part of the encapsulation layer 2 is located in the encapsulation region A2. The encapsulation layer 2 is at least in contact with a side surface S61 of the long-wave passing material layer 61. The side surface S61 of the long-wave passing material layer 61 intersects the plane of the light filter 100.

The part of the encapsulation layer 2 located in the encapsulation region A2 can prevent water vapor from entering from the side surface S61 of the long-wave passing material layer 61 and eroding the long-wave passing material layer 61, thereby protecting the long-wave passing material layer 61 made of a metal layer from being eroded by water and oxygen in the external environment, reducing the possibility that the long-wave passing material layer 61 in the light filter 100 is oxidized and corroded, and extending the life of the light filter 100 and improving its reliability. In the embodiment of the present disclosure, the encapsulation layer 2 is in contact with the side surface S61 of the long-wave passing material layer 61, so that the encapsulation layer 2 and the short-wave passing material layer 62 in contact with the surface of the long-wave passing material layer 61 can jointly enclose the long-wave passing material layer 61, and the long-wave passing material layer 61 can be prevented from contacting the external environment from multiple directions, thereby improving the reliability of the light filter 100.

Some embodiments of the present disclosure also provide a head up display (HUD). As shown in FIG. 2, the HUD includes an image generating element 51, an imaging module 52, and the above light filter 100. The image generating element 51 is configured to emit light within the first waveband. In some embodiments, the image generating element 51 includes a liquid crystal display. For example, the image generating element 51 may emit display light corresponding to display information. The display light includes the light within the first waveband. The displayed information includes the current speed or navigation information. The imaging module 6 is configured to receive the light within the first waveband emitted by the image generating element 51 and form an image. For example, the imaging module 6 is configured to receive the light within the first waveband emitted by the image generating element 51 and reflect it into human eyes for imaging. Exemplarily, the imaging module 52 includes a windshield of a transport means such as an airplane or a car. As shown in FIG. 2, the display light can reach an eye box 53 after being reflected by the imaging module 52. When the driver's eyes are within the scope of the eye box 53, the driver can observe a virtual image 54 formed by the display light at another side of the imaging module 52, so that the driver can view information, such as speed and/or navigation, without turning head or lower head, which can improve driving safety. Since the imaging module 52 can also transmit external light, an augmented reality effect formed by superimposing by the virtual image 54 and the external ambient light can be visible by the user through the imaging module 52.

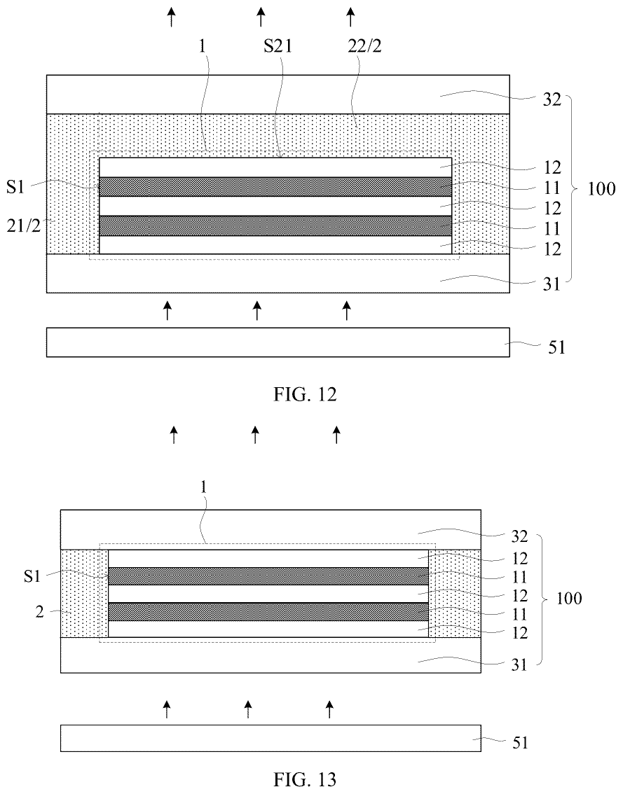

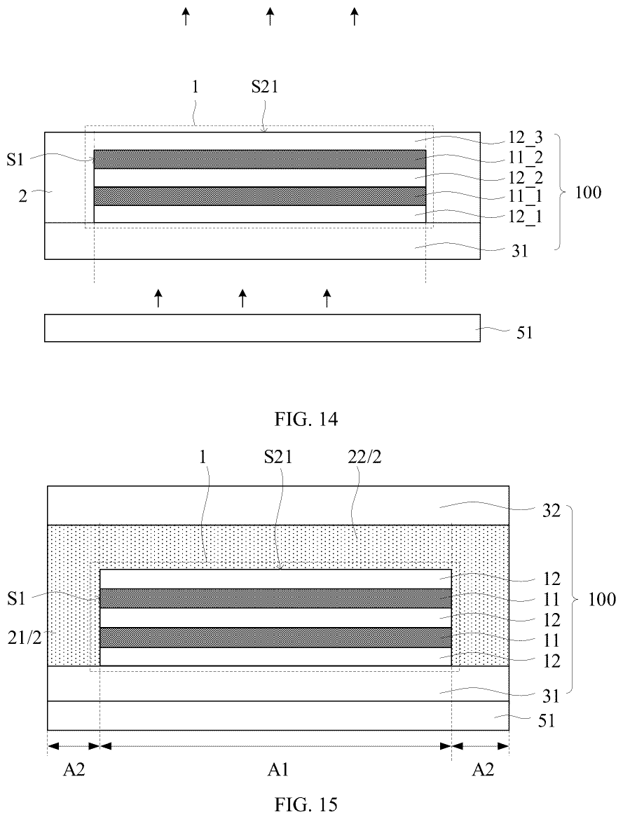

The light filter 100 is located on the optical path between the image generating element 51 and the imaging module 52. FIG. 2 illustrates that the light filter 100 is in contact with the light-exiting surface of the image generating element 51. FIG. 12, FIG. 13, and FIG. 14 are schematic diagrams of positional relationships between three light filters and image generation element provided by embodiments of the present disclosure, respectively. In some embodiments, as shown in FIG. 12, FIG. 13, and FIG. 14, the light filter 100 is spaced apart from the image generating element 51. FIG. 12 illustrates that the first part 21 and the second part 22 of the encapsulation layer 2 are formed into one piece, and FIG. 13 and FIG. 14 illustrate that the encapsulation layer 2 is formed only in the encapsulation region A2. In FIG. 14, the second layer located at the outermost of the optical layer group 1, that is, the second layer 12_3, is formed into one piece with the encapsulation layer 2.

Conventionally, sunlight will pass through the imaging module 52 and be incident to the image generating element 51, leading to a sunlight intrusion phenomenon, which causes the temperature of the image generating element 51 to increase and affects the operation performance of the image generating element 51. In the embodiments of the present disclosure, the light filter 100 is disposed on the optical path between the image generating element 51 and the imaging module 52. When the sunlight passes through the imaging module 52 and is incident to the image generating element 51, the light filter 100 located on the optical path between the image generating element 51 and the imaging module 52 can weaken or isolate the transmission of the light within the second waveband in sunlight, thereby preventing the energy of light within the second waveband from reaching the image generating element 51. In this way, the effect of external light on the image generating element 51 can be alleviated, the increase in the temperature of the image generating element 51 is suppressed, the stable operation of the image generating element 51 is ensured, and the reliability of the HUD is improved. While ensuring thermal insulation, when the HUD operates, the light within the first waveband emitted by the image generating element 51 can normally pass through the light filter 100 to reach the imaging module 52 and then is reflected by the imaging module 52, ensuring the display effect of the HUD. A slight color cast problem caused by the light filter 100 can be corrected through an image algorithm, ensuring the restoring degree of the HUD image.

For example, the display light emitted by the image generating element 51, such as the light within the first waveband, can be directly incident to the imaging module 52, and the reflection characteristics of the imaging module 52 are utilized to present a virtual image. As shown in FIG. 2, in some embodiments of the present disclosure, a reflective element 55 may be provided in the HUD. The reflective element 55 is located on the optical path of the display light emitted by the image generating element 51. The reflective element 55 is configured to reflect the display light, and finally reflect the display light to the imaging module 52. Exemplarily, the reflective element 55 includes a curved mirror or a plane mirror.

It should be understood that when the HUD includes the reflective element 55, the light filter 100 may be located on an optical path between the image generating element 51 and the reflective element 55, or the light filter 100 may be located on an optical path between the reflective element 55 and the imaging module. 52.

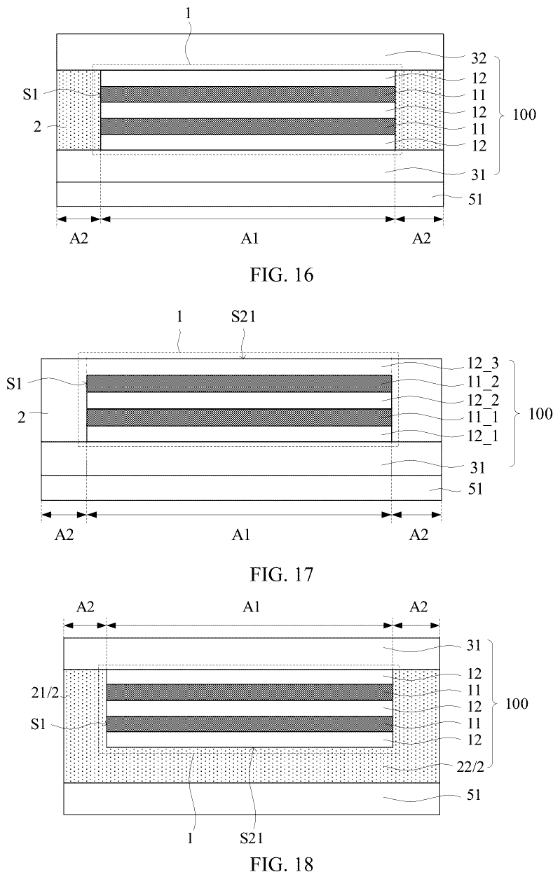

For example, as shown in FIG. 2, in some embodiments of the present disclosure, the light-exiting surface of the image generating element 51 may be in contact with the light filter 100. FIG. 15, FIG. 16 and FIG. 17 are schematic diagrams of positional relationships of another three light filters and image generating elements provided by embodiments of the present disclosure, respectively, and illustrate that the light-exiting surface of the image generating element 51 is in contact with the first substrate 31 in the light filter 100. For example, FIG. 15 illustrates that the first part 21 and the second part 22 of the encapsulation layer 2 are formed into one piece, and FIG. 16 and FIG. 17 illustrate that the encapsulation layer 2 is formed only in the encapsulation region A2. In FIG. 17, the second layer located at the outermost of the optical layer group 1, that is, the second layer 12_3, is formed into one piece with the encapsulation layer 2.

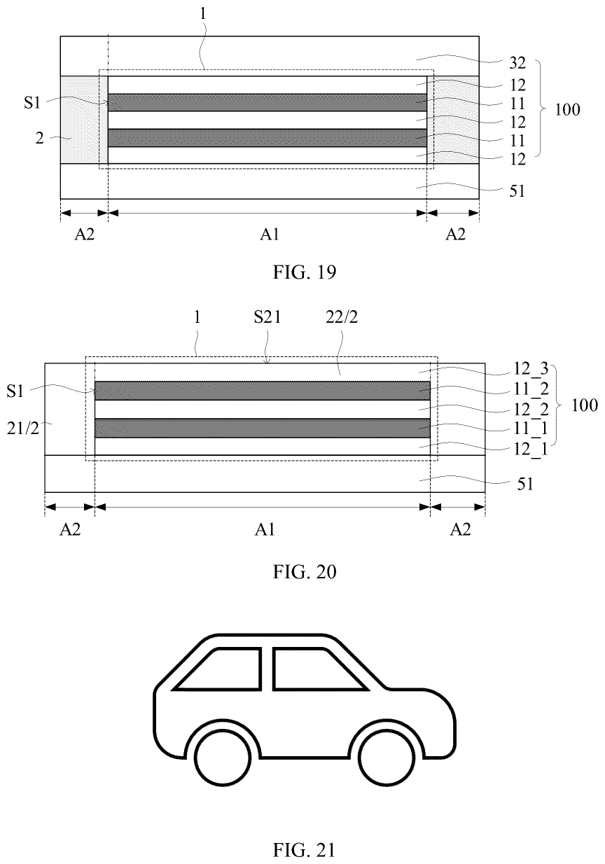

FIG. 18, FIG. 19, and FIG. 20 are schematic diagrams of positional relationships of another three light filters 100 and image generating element 51 provided by embodiments of the present disclosure, respectively. For example, as shown in FIG. 18, FIG. 19, and FIG. 20, the optical layer group 1 in the light filter 100 can be in contact with the image generating element 51. For example, FIG. 18 illustrates that the first part 21 and the second part 22 of the encapsulation layer 2 are formed into one piece, without the second substrate 32 in FIG. 1. FIG. 19 and FIG. 20 illustrate that the encapsulation layer 2 is formed only in the encapsulation region A2. In FIG. 20, the second layer located at the outermost of the optical layer group 1, that is, the second layer 12_3, is formed into one piece with the encapsulation layer 2.

When preparing the light filter 100 and the image generating element 51 with the structure shown in FIG. 18, for example, the first substrate 31 can be provided first, and then the optical layer group 1 including the first layer 11 and second layer 12 is formed at a side of the first substrate 31, then the image generating element 51 is provided, and the light filter 100 including the first substrate 31 and the optical layer 1 is fixed on the light-exiting surface of the image generating element 51 using the encapsulation layer 2, that is, without the second substrate 32 in the light filter 100 having the structure shown in FIG. 1.

When preparing the light filter 100 and the image generating element 51 with the structures shown in FIG. 19 and FIG. 20, the image generating element 51 can be provided first, and then the optical layer group 1 including the first layer 11 and the second layer 12 is formed on the surface of the image generating element 51, that is, the image generating element 51 can be used as a preparation base of the optical layer group 1. For example, as shown in FIG. 19, after the preparation of the optical layer group 1 is completed, a second substrate 32 can be disposed at a side of the optical layer group 1 away from the image generating element 51, and the second substrate 32 can protect the optical layer group 1.

In the embodiments of the present disclosure, the optical layer group 1 is in contact with the image generating element 51, the optical layer group 1 can be directly formed on the surface of the image generating element 51, and the overall thickness of the image generating element 51 and the light filter 100 can be reduced.

Some embodiments of the present disclosure provide a transport means. FIG. 21 is a schematic diagram of a transport means provided by some embodiments of the present disclosure. For example, as shown in FIG. 21, the transport means includes the above HUD. In some embodiments, the transport means includes a vehicle, and the vehicle includes a body and the above HUD.

The transport means provided by the embodiments of the present disclosure can project the current speed, navigation and other information of the transport means onto the windshield of the transport means by the HUD for imaging, so as to form an image in front of the windshield, allowing the driver to see navigation and/or vehicle speed information without turning head or lowering head, which improves driving safety. In the embodiments of the present disclosure, with the light filter in the HUD, the problem of sunlight intrusion can be solved and improved, thereby improving the reliability of the image generating element in the HUD.

It can be understood that the transport means shown in FIG. 21 is only a schematic illustration, and the transport means may be a car, a train, a high-speed rail, a ship, or an airplane, etc.

The above are only exemplary embodiments of the present disclosure and are not intended to limit the present disclosure. Any modifications, equivalent substitutions, improvements, etc. made within the principle of the present disclosure shall be included in the protection of the present disclosure.

Finally, it should be understood that the above embodiments are only used to illustrate the technical solution of the present disclosure, but not to limit it. Although the present disclosure has been described in detail with reference to the foregoing embodiments, those of ordinary skill in the art should understand that they can still modify the technical solutions described in the foregoing embodiments, or equivalently replace some or all of the technical features, and these modifications or substitutions do not cause the essence of the corresponding technical solutions to deviate from the scope of the technical solutions of the embodiments of the present disclosure.

What is claimed is:

1. A light filter having an optical transmission region and comprising an optical layer group arranged in the optical transmission region, wherein transmittance of the optical layer group to light within a first waveband is greater than transmittance of the optical layer group to light within a second waveband, and wherein the optical layer group comprises a first layer and a second layer that are stacked together, a refractive index of the first layer being different from a refractive index of the second layer, and the first layer comprising a metal layer.

2. The light filter according to claim 1, further having an encapsulation region surrounding the optical transmission region, and the light filter further comprising an encapsulation layer, wherein at least part of the encapsulation layer is located in the encapsulation region, the encapsulation layer is in contact with at least a side surface of the first layer, and the side surface intersects a plane of the light filter.

3. The light filter according to claim 2, wherein the encapsulation layer comprises a first part and a second part, the first part is located in the encapsulation region and is in contact with the side surface of the first layer, and the second part is located in the optical transmission region and is attached to a first surface of the optical layer group, the first surface of the optical layer group being parallel to the plane of the light filter.

4. The light filter according to claim 3, wherein the first surface comprises a surface of the second layer away from the first layer.

5. The light filter according to claim 3, wherein the first part and the second part are formed into one piece.

6. The light filter according to claim 3, wherein the second part has a thickness greater than a thickness of the second layer and greater than a thickness of the first layer.

7. The light filter according to claim 3, wherein the first part and the second part each comprises an optical clear adhesive.

8. The light filter according to claim 2, wherein the optical layer group comprises at least two second layers, and the first layer is arranged alternately with the at least two second layers; and
the encapsulation layer comprises at least two encapsulation sub-layers stacked along a thickness direction of the light filter, and an encapsulation sub-layer of the at least two encapsulation sub-layers and one second layer of the at least two second layers that is closest to the encapsulation sub-layer are formed into one piece.

9. The light filter according to claim 2, wherein the optical layer group comprises at least two second layers, and the first layer is located between two second layers of the at least two second layers; and
one second layer of the at least two second layers that is located at outermost of the optical layer group and the encapsulation layer are formed into one piece.

10. The light filter according to claim 2, further comprising: a first substrate and a second substrate, wherein the optical layer group is located between the first substrate and the second substrate.

11. The light filter according to claim 10, wherein the at least part of the encapsulation layer is located between the first substrate and the second substrate, and the encapsulation layer is in contact with both the first substrate and the second substrate.

12. The light filter according to claim 10, wherein the encapsulation layer is also in contact with at least one of a side surface of the first substrate or a side surface of the second substrate, and both the side surface of the first substrate and the side surface of the second substrate intersects the plane of the light filter.

13. The light filter according to claim 2, wherein the encapsulation region has a width w, where 0.5 mm≤w≤3 mm.

14. The light filter according to claim 1, wherein the refractive index of the first layer is n₁, and the refractive index of the second layer is n₂, where 1.8≤n₂−n₁≤2.75.

15. The light filter according to claim 1, wherein the second layer comprises at least two sub-layers stacked together.

16. The light filter according to claim 1, wherein the first layer comprises one of or an alloy of two or more of: silver, iron, nickel, titanium, copper, tin, or aluminum, and
wherein the second layer comprises oxide.

17. A light filter comprising an optical layer group,
wherein transmittance of the optical layer group to light within a first waveband is greater than transmittance of the optical layer group to light within a second waveband, and wherein the optical layer group comprises a long-wave passing material layer and a short-wave passing material layer that are stacked together.

18. A head up display device, comprising:
an image generating element configured to emit light within a first waveband;
an imaging module configured to receive the light within the first waveband and to perform imaging; and
a light filter located on an optical path between the image generating element and the imaging module,
wherein the light filter has an optical transmission region and the light filter comprises an optical layer group arranged in the optical transmission region, and
wherein transmittance of the optical layer group to the light within the first waveband is greater than transmittance of the optical layer group to light within a second waveband, the optical layer group comprises a first layer and a second layer that are stacked together, a refractive index of the first layer is different from a refractive index of the second layer, and the first layer comprises a metal layer.

19. The head up display device according to claim 18, wherein a light-exiting surface of the image generating element is in contact with the light filter, or wherein the optical layer group is in contact with the image generating element.

20. A transport means, comprising the head up display device according to claim 18.
